(19) United States
(12) Patent Application Publication
(10) Pub. No.: US 2014/0212635 A1
(43) Pub. Date: Jul. 31, 2014

(54) METHOD FOR PRINTING A HIGH RESOLUTION IMAGE ON DARK FABRIC

(71) Applicant: ACCOLADE GROUP INC., Richmond Hill (CA)

(72) Inventor: Hyman Ngo, Toronto (CA)

(73) Assignee: ACCOLADE GROUP INC., Richmond Hill (CA)

(21) Appl. No.: 13/754,272

(22) Filed: Jan. 30, 2013

(51) Int. Cl. D06P 5/28; B41F 15/00

(52) U.S. Cl. CPC D06P 5/004; B41F 15/00
USPC 428/196; 101/490; 101/115

(57) ABSTRACT

A method for printing an image onto fabric, preferably a dark fabric, comprises the steps of transferring an image to the fabric to provide a transferred image on the fabric; and, subsequently applying a highlight that is lighter in color than the dark color to at least a portion of the fabric surrounding the transferred image and/or a margin of the transferred image. A fabric such as a T-shirt comprising a sublimated image and white highlights is also provided.

### FIELD

The invention relates to a method for printing a high resolution image on a fabric, which is preferably a dark colored fabric.

### INTRODUCTION

Sublimation printing allows the transfer of high resolution images to fabric.

Sublimation printing is generally known in the art and comprises using heat sensitive dyes also known as sublimation dyes) to print a desired image onto a transfer substrate. The fabric surface to be printed and the transfer substrate are then heat pressed at a high temperature. The heat causes the solid dye contained on the transfer substrate to vaporize into a gas. At the same time, the pores of the fabric open and allow the dye vapor to enter the fabric. As the temperature drops, the fibers close and the gas reverts to a solid state, trapping the dye in the fabric. As a result, the image is transferred to the fabric.

There are limitations to the use of sublimation printing. For example, while sublimation printing produces high quality images on white or light colored fabrics, sublimation printing does not work well on dark colored fabrics.

### SUMMARY

The following summary is provided to introduce the reader to the more detailed discussion to follow. The summary is not intended to limit or define the claims.

The present inventors describe herein a new method for printing high quality images on dark fabrics. In accordance with the method disclosed herein, a light color, preferably white, is printed onto a fabric surrounding a portion or all of a transferred image and/or a portion of the transferred image. This additional printing step provides enhanced contrast between the transferred image and the fabric color.

Therefore, according to one broad aspect of this disclosure, a method is provided for printing an image onto a fabric having a dark color comprising the steps of:
(a) transferring an image to the fabric to provide a transferred image on the fabric; and,
(b) subsequently applying a highlight that is lighter in color than the dark color to at least a portion of the fabric surrounding the transferred image and/or a margin of the transferred image.

In one embodiment, step (b) comprises aligning the highlight to be applied to the fabric adjacent to at least a portion of the transferred image and/or a margin of the transferred image.

In another embodiment, the transferred image has one or more sections that are spaced apart to define at least one open area wherein the fabric is visible in the at least one open area and the method further comprises applying the highlight to the fabric in at least one open area and/or to the margin of a section bordering the open area.

In another embodiment, the method further comprises selecting as the fabric an off-black fabric, a dark blue fabric, a dark green fabric, a grey fabric, a cardinal fabric, a red fabric, an orange fabric, a royal blue fabric, a charcoal fabric, a dark brown fabric, a dark grey fabric or a black fabric.

In another embodiment, the method further comprises selecting as the fabric a dark blue fabric, a dark green fabric, a grey fabric, a cardinal fabric, a red fabric, an orange fabric, a royal blue fabric, a charcoal fabric, a dark brown fabric or a dark grey fabric.

In another embodiment, the image is transferred using sublimation printing.

In another embodiment, the highlight is white.

In another embodiment, the highlight is applied using screen printing.

In another embodiment, the fabric comprises a natural fiber.

In another embodiment, the fabric comprises cotton or a cotton blend.

In another embodiment, the transferred image has a resolution of at least 300 DPI.

In another broad aspect of the disclosure, the disclosure relates to a fabric comprising:
(a) a sublimated image; and,
(b) a highlight lighter in color than the fabric printed surrounding at least a portion of the sublimated image and/or a margin of the transferred image.

In one embodiment, the sublimated image comprises an intermediary layer between the fabric layer and the white or light colored highlights.

In one embodiment, the highlight is white.

In another embodiment, the sublimated image has one or more sections that are spaced apart to define at least one open area, wherein the fabric is visible in the at least one open areas and the highlight is positioned in the at least open area and/or on a margin of a section bordering the open area.

In another embodiment, the highlight is screen-printed.

In another embodiment, the fabric is in the form of a garment.

In another embodiment, the fabric is a dark blue fabric, a charcoal fabric, a dark brown fabric, a dark grey fabric or a black fabric.

In another embodiment, the fabric is a dark blue fabric, a charcoal fabric, a dark brown fabric or a dark grey fabric.

The disclosure also relates to a fabric article produced by the methods described above.

One advantage of the method is that it provides an efficient and cost-effective method for printing high-resolution images (e.g., a resolution of at least 300 DPI and preferably at least 360 DPI) on dark fabrics.

Another advantage of the method is that it provides a finished product (e.g., a garment) having a durable, bright, high-resolution image that is easily distinguishable on a fabric that would otherwise provide a dark background.

### DRAWINGS

Reference is made in the description of various embodiments to the accompanying drawings, in which:

FIG. 1 is a transfer image prior to being transferred;

FIG. 2 is a dark cotton blend t-shirt having a transferred image thereon; and,

FIG. 3 is a dark cotton blend t-shirt printed according to one embodiment of the disclosure.

### DESCRIPTION OF VARIOUS EMBODIMENTS

Various processes and compositions will be described below to provide an example of each claimed invention. No invention described below limits any claimed invention and any claimed invention may cover processes and compositions that are not described below. The claimed inventions are not limited to processes and compositions having all of the features of any one process or composition, or to features common to multiple or all of the processes or compositions described below. It is possible that a process or composition described below is not an embodiment of any claimed inventions.

In accordance with the present disclosure, a method is provided for printing an image on a dark colored fabric. According to this embodiment, the process comprises providing a fabric to be printed, transferring an image to the fabric and then applying a light colored highlight, preferably white, to at least a portion of the fabric surrounding the transferred image and/or a margin of the transferred image.

The fabric may be made from a natural fiber, a synthetic fiber or a blend thereof. The fabric may be made from one or more natural fibers and may optionally be combined with one or more synthetic fibers. The natural fabric may be cotton, wool, hemp, silk and linen or a blend thereof and preferably comprises or consists essentially of cotton. The synthetic fiber may be polyester, nylon, lycra, spandex and blends thereof and preferably comprises polyester. An exemplary fabric may be cotton or a cotton blend such as a blend of cotton and polyester. In one particular embodiment, the cotton blend may comprise at least about 50%, preferably at least about 75% and more preferably at least about 95% cotton. In another embodiment, the cotton blend is a blend of cotton and polyester, optionally a blend of 50% cotton and 50% polyester or a blend of cotton and at least 50% polyester. Other cotton blends include blends of about 60% cotton/40% polyester, 35% cotton/65% polyester and 40% cotton/60% polyester.

In one embodiment of the disclosure, the fabric is dark-colored. Examples of dark colors include, but are not limited to, off-black, dark blue, dark grey, dark green, dark brown, grey, cardinal, charcoal, red, orange, royal blue and black. A preferred color is dark grey or charcoal.

The fabric may be any size that is suitable for printing. Accordingly, the fabric may be a finished product such as a garment. The garment may be a t-shirt, sweat-shirt, tank-top, shorts, pants, socks, bandana, scarf, shawl, hat, dress, or jacket, and is preferably a t-shirt, sweat-shirt, tank-top or shorts. The fabric may also include household items including, but not limited to, towels, clothes, placemats or table clothes.

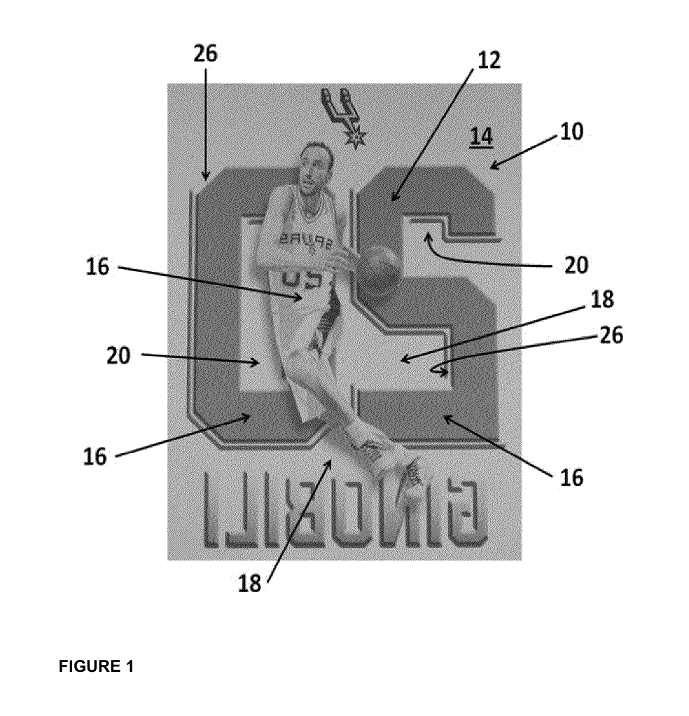

The image may be transferred to the fabric using any known process. Preferably, the image is transferred using heat. A preferred process is sublimation printing, namely printing an image onto a transfer substrate and then transferring the image to the fabric through the use of heat. The transfer for use in the printing process may be of any design. As shown in FIG. 1, transfer 10 comprises an image 12 provided on a substrate 14. Preferably, as shown, the image includes a plurality of sections 16 that are positioned or spaced apart such that open areas 18 are provided between two or more sections 16. Alternately or in addition, one or more sections 16 may have an area 20 that is partially or fully surrounded by a section 16. Sections 16 that are the numbers “2” and “0” also have a margin 26 that is a lighter color. It will be appreciated that any of the margins or perimeters of a section 16 may be the same or a different color.

Any method of sublimation printing known in the art may be used in the present process.

In one aspect of the disclosure, sublimation printing comprises:
(a) printing an image onto a transfer substrate using sublimation inks; and,
(b) positioning the transfer substrate on the fabric and applying heat and pressure to transfer the sublimation inks to the fabric.

According to one embodiment, an image, preferably a high-resolution image (e.g., equal to or greater than 300 DPI, equal to or greater than 360 dpi, equal to or greater than 600 DPI or equal to or greater than 720 DPI, i.e., dots per inch) is prepared using an appropriately programmed computer. An exemplary program that may be used is Adobe Illustrator. The reverse image of the final design may then be digitally printed using sublimation inks onto the transfer substrate. Appropriate printers, inks and transfer substrates are known in the art and are available from various suppliers. For example, the transfer substrate may be paper, cardboard, cloth, foil, plastic, film or any other material that can carry ink. In one embodiment of the disclosure, the transfer substrate is transfer paper.

In accordance with sublimation printing, the image is transferred to the fabric using a combination of heat and pressure. Preferably, the image is transferred at a temperature of, e.g., 375° F. to 475° F. and preferably 400° F. to 450° F. The fabric and transfer substrate are pressed together with an applied pressure of, e.g., at least 60 pounds per inch, and preferably at least 100 to 120 pounds per inch. The heat and pressure may be applied for 25 to 60 seconds and, preferably, 30 to 45 seconds.

The image is optionally a high-definition image and it may be a photograph or a digitally created image. The image may be a black and white image, grey-scale image or, preferably, a color image. Preferably, the high-resolution image is an image with a DPI value equal to or greater than 300 DPI, equal to or greater than 360 DPI, equal to or greater than 600 DPI or equal to or greater than 720 DPI.

The transfer substrate is optionally aligned on the fabric prior to sublimation. This may include or consist of positioning the transfer such that the image, post transfer, is located at the desired position and in the desired orientation on the fabric. In a preferred embodiment, the transfer substrate is aligned with a screen for subsequent screen printing of one or more highlights. This allows the later application of a highlight in the appropriate position or positions relative to the sublimated image. Any method known in the art may be used to align the transfer substrate with the screen. In one embodiment, a pin registration system is used to align the transfer substrate. Alternately, the image may include one or more alignment markers for subsequent use in applying a highlight.

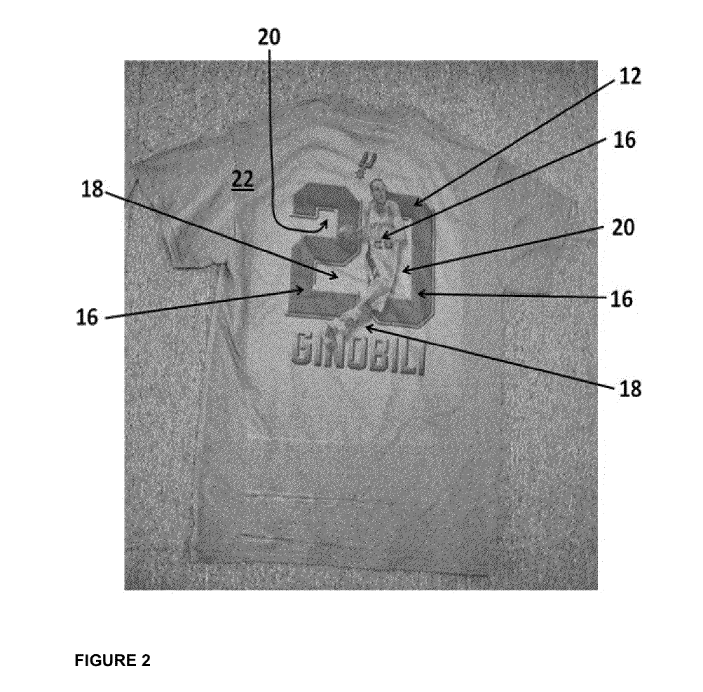

As shown in FIG. 2, image 12 is transferred to garment 22. Fabric is visible in open areas 18 that are positioned between portions 16 of the image 12 and open areas 20 of a section 16.

A base coat is optionally applied to the fabric prior to sublimation printing. In one embodiment, the base coat is applied to fabrics with a polyester content of less than 50%. The base coat composition optionally includes an organosilicon compound such as polydimethylsiloxane. In one aspect of the disclosure, the base coat is applied as a liquid base coat mixture and the fabric is dried prior to printing.

After the sublimation image is transferred onto the fabric, one or more highlights may be applied. If more than one highlight is provided (e.g., more than one part of the interface of the fabric and the transferred image is highlighted), then the highlights are preferable applied at the same time. It will be appreciated that if a plurality of highlights are to be applied, they may be applied in a series of steps or at the same time

The highlight is a light color and may be cream, beige pale yellow or white and is preferably white. In another embodiment, the highlight is a color that is lighter than the color of the fabric. The highlight color may be selected to provide a desired contrast between the fabric and the border or margin of the transferred image. Accordingly, the visibility of the transferred image is enhanced.

The highlight may be an ink that is applied to the fabric. The highlight may be applied by any method known in the art. In one embodiment, the highlight is applied by screen printing. In another embodiment, the highlight is applied by digital printing such as Direct To Garment (DTG) printing.

Any method of screen printing or DTG printing known in the art may be used in the present process. Appropriate inks and screens are known in the art and are available from various suppliers.

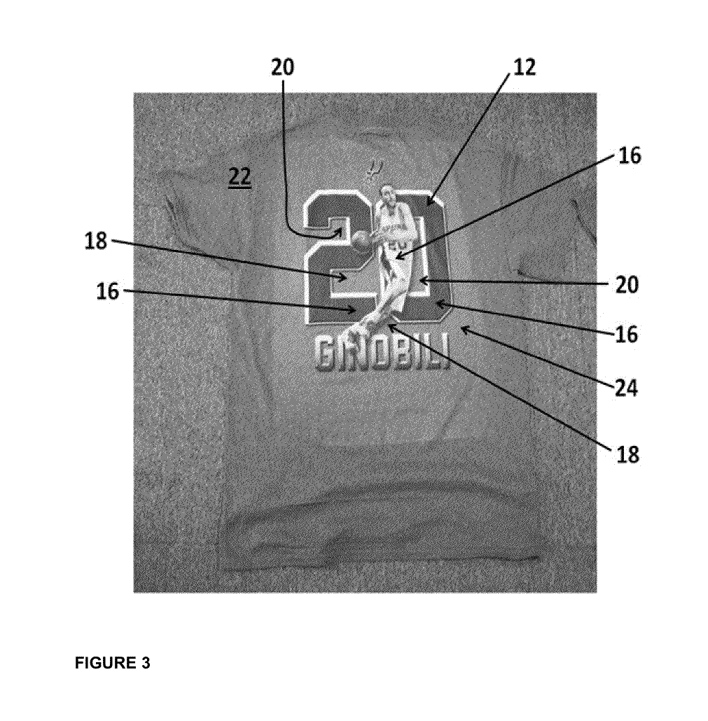

In one embodiment, a screen for screen printing is made of a piece of mesh stretched over a frame. Parts of the screen that are aligned with the image 12 define areas in which a highlight is not to be applied. These parts of the screen may be solid. The portions of the screen that are aligned with spaces are where the highlights will appear on the fabric are open. Referring to FIG. 3, the screen may be designed to permit a highlight to be printed surrounding part or all of one or more section 16 and/or overlying part or all of a section 16. Accordingly, a highlight may be printed on the fabric in one or more open areas 18, 20 and/or a highlight may be over printed on part or all of a section 16. As exemplified in FIG. 3, for example, a white highlight is printed over the letters of the name. A white highlight is also printed on part of the margin 26 of the numbers “2” and “0”. It will be appreciated that the highlight may alternately be printed on the fabric surrounding the numbers or both on the fabric surrounding the numbers and on the margins 26. While not pictured in FIG. 3, the screen may also be designed to permit a highlight to be printed in peripheral region 24.

Accordingly, the screen may be placed on top of the transferred image, and in alignment with the transferred image. White or light colored ink may then be applied such that the ink is deposited on to the fabric in the selected places. Accordingly, white or light colored highlights are applied to outline part or all of the transferred image.

The highlight may be applied to at least a portion of the fabric surrounding the transferred image. According to the present methods, the highlight may also be applied to at least a portion of the transferred image, e.g., a margin 26 of the transferred image. For example, this may occur to provide a highlight surrounding part or all of a transferred image or to overlie part or all of a transferred image. In some embodiments, the highlight is applied to at least 0.5%, 1%, 2% or 5% of the transferred image.

### EXAMPLES

### Example 1

### T-shirt Printed without any Highlight

The T-Shirt shown in FIG. 2, a blend of cotton and polyester, was printed according to the following process.
1. A graphic image was designed and digitally printed onto sublimation transfer paper.
2. The T-Shirt was loaded onto a station for sublimation printing.
3. The transfer paper was aligned on the T-shirt and heat was applied to the garment at 400 to 450° F. for 30 to 45 seconds to transfer the image to the T-shirt.
4. The transfer paper was peeled off the T-Shirt to expose the transferred image.

### Example 2

### T-shirt Printed According to an Embodiment of the Disclosure

The T-Shirt shown in FIG. 3, a blend of cotton and polyester, was printed according to the following process.
1. A graphic image was designed and digitally printed onto sublimation transfer paper.
2. The T-Shirt was loaded onto a station for sublimation printing.
3. The transfer paper was aligned on the T-shirt and heat was applied to the garment at 400 to 450° F. for 30 to 45 seconds to transfer the image to the T-shirt.
4. The transfer paper was peeled off the T-Shirt to expose the transferred image.
5. White highlights were screen printed onto the T-Shirt.
6. The garment was dried for 30 to 35 seconds at 275 to 300° F.

What has been described above has been intended illustrative and non-limiting and it will be understood by persons skilled in the art that other variances and modifications may be made without departing from the scope of the disclosure as defined in the claims appended hereto.

1. A method for printing an image onto a fabric having a dark color comprising the steps of:
(a) transferring an image to the fabric to provide a transferred image on the fabric; and,
(b) subsequently applying a highlight that is lighter in color than the dark color to at least a portion of the fabric surrounding the transferred image and/or a margin of the transferred image.

2. The method of claim 1, wherein step (b) comprises aligning the highlight to be applied to the fabric adjacent to at least a portion of the transferred image and/or a margin of the transferred image.

3. The method of claim 2, wherein the transferred image has one or more sections that are spaced apart to define at least one open area wherein the fabric is visible in the at least one open area and the method further comprises applying the highlight to the fabric in at least one open area and/or to the margin of a section bordering the open area.

4. The method of claim 1, further comprising selecting as the fabric an off-black fabric, a dark blue fabric, a dark green fabric, a grey fabric, a cardinal fabric, a red fabric, an orange fabric, a royal blue fabric, a charcoal fabric, a dark brown fabric, a dark grey fabric or a black fabric.

5. The method of claim 1, further comprising selecting as the fabric a dark blue fabric, a dark green fabric, a grey fabric, a cardinal fabric, a red fabric, an orange fabric, a royal blue fabric, a charcoal fabric, a dark brown fabric or a dark grey fabric.

6. The method of claim 1, wherein the image is transferred using sublimation printing.

7. The method of claim 1, wherein the highlight is white.

8. The method of claim 1, wherein the highlight is applied using screen printing.

9. The method of claim 1, wherein the fabric comprises a natural fiber.

10. The method of claim 9, wherein the fabric comprises cotton or a cotton blend.

11. The method of claim 1, wherein the transferred image has a resolution of at least 300 DPI.

12. A dark fabric comprising:
(a) a sublimated image; and,
(b) a highlight lighter in color than the fabric printed surrounding at least a portion of the sublimated image and/or a margin of the transferred image.

13. The fabric of claim 12, wherein the highlight is white.

14. The fabric of claim 12, wherein the sublimated image has one or more sections that are spaced apart to define at least one open area, wherein the fabric is visible in the at least one open areas and the highlight is positioned in the at least open area and/or on a margin of a section bordering the open area.

15. The fabric of claim 12, wherein the highlight is screen-printed.

16. The fabric of claim 12, wherein the fabric is in the form of a garment.

17. The fabric of claim 12, wherein the fabric is an off-black fabric, a dark blue fabric, a dark green fabric, a grey fabric, a cardinal fabric, a red fabric, an orange fabric, a royal blue fabric, a charcoal fabric, a dark brown fabric, a dark grey fabric or a black fabric.

18. The fabric of claim 12, wherein the fabric is a dark blue fabric, a dark green fabric, a grey fabric, a cardinal fabric, a red fabric, an orange fabric, a royal blue fabric, a charcoal fabric, a dark brown fabric or a dark grey fabric.

19. A fabric produced by the method of claim 1.
